(19) United States
(12) Patent Application Publication
(10) Pub. No.: US 2014/0061136 A1
(43) Pub. Date: Mar. 6, 2014

(54) SEDIMENT CONTROL SYSTEM

(71) Applicant: Innovative Turf Solutions, LLC, Cincinnati, OH (US)

(72) Inventor: Melissa Schrand, Cincinnati, OH (US)

(73) Assignee: Innovative Turf Solutions, LLC, Cincinnati, OH (US)

(21) Appl. No.: 14/010,530

(22) Filed: Aug. 27, 2013

Related U.S. Application Data
(60) Provisional application No. 61/697,034, filed on Sep. 5, 2012.

(51) Int. Cl. C02F 1/52

(52) U.S. Cl. CPC C02F 1/5236
USPC 210/702; 210/198.1; 210/200; 210/207

(57) ABSTRACT

An apparatus and method treats contaminated water by encompassing within a water-permeable enclosure a clay-based flocculant material for reducing a contaminant entrained in a flow of contaminated water. In one embodiment, the material further comprises a polyacrylamide composition. A placement member attaches to the water-permeable enclosure to impede the flow of contaminated water. An attached or proximately positioned filter captures the flocculant. Alternatively, the flocculant is captured in a clarification settling basin.

### CROSS-REFERENCE TO RELATED APPLICATIONS

This application claims the benefit of priority under 35 U.S.C. §119(e) to U.S. Provisional Application Ser. No. 61/697,034 entitled “SEDIMENT CONTROL SYSTEM”, filed Sep. 5, 2012, the contents of which are hereby incorporated by reference in their entirety.

### BACKGROUND OF THE INVENTION

1. Field of the Invention

The field of art disclosed herein pertains to compositions, devices and methods for the control of sediment in water, water entrained contaminants to include hydrocarbons, heavy metals, suspended solids and other constituents that contribute to water pollution.

2. Description of the Related Art

Sediment is the largest water pollution source in the United States waterways. All 50 states require sediment control as a best management practice (BMP) as a minimum control barrier to protect the nations waterways. The BMPs often dictate one or more forms of sediment retention devices (SRDs). The sources of these water pollutants are both natural and man-made. The pollutant elements or compounds enter into the waterways from precipitation (rain or snow melt) and the contaminants are dissolved or absorbed into these run off waters. Nature has a means to retain or slow these run off waters with natural vegetation such as grasses, brush, and rocks. In unnatural situations such as agricultural, construction, mining, environmental remediation, or other man-made sites, these natural barriers do not exist. Therefore SRDs must be implemented to comply with the regulated BMPs and environmental permits requirements.

Starting in the early 1990s, requirements for the sediment retention devices grew and legislation has increased to the level of pollution removal based on the development of newer technologies. There are many of these devices available to the industry with limited data and application knowledge to properly apply and remove the contaminants of concern. Typical SRDs used today are in the form of rock traps to minimize erosion, fences and drainage channels to control the direction of the water and finally a clarification and settling basin to allow the suspended solids to settle to the bottom as the simplest filtering form of SRD. There are many variants that have been developed to include in situ water filtering devices SRDs such as permeable mediums to protect storm drains, staged barriers with filtration, settling basin decanters for drainage from the top of the water level (most clarified), in-ground filtering boxes and other solids removal devices. The filtering media is composed of natural fibers such as straw, hemp, sawdust and other common fibrous material. Other filtering media includes man-made media such as resin fibers, synthetics and fabrics. These reduce the space required as compared to settling of the solids by direct filtration. These technologies have an industry acceptance of an 80% removal efficiency based on visual inspection of the before and after water clarity.

More recently, chemicals have been introduced and used in conjunction with these SRDs to further increase the contaminant removal efficiencies and reduce the SRDs area and expense. These include the use of chitosan and other natural absorbents, coagulants, and polymers that are directly added to the flow stream. These approaches have reduced the visual clarity to over 90%, but this has proven insufficient to meet the ever-tightening regulations in most states.

Recent legislation has been adopted in most of the 50 states to include levels that are 50% lower than 5 years ago. The regulations are developed by analysis of each public waterways level of TMDLs (Total Maximum Daily Load). Once a level of allowable toxicity is determined in a waterway, the levels of contaminants from individual dischargers in the form of storm water permits, construction and even NPDES (National Pollution Discharge Elimination System as part of the Clean Water Act) are set. Current SRD technologies cannot meet these limits as these regulations require removal of heavy metals, hydrocarbons, and other contaminants from these waters. Therefore, a new technology is needed that can meet and exceed these required discharge limits.

### SUMMARY OF THE INVENTION

In one aspect, the present disclosure provides an apparatus for treatment of contaminated water. A water-permeable enclosure encompasses a clay-based flocculant material for reducing a contaminant entrained in a flow of contaminated water. A placement member attached to the water-permeable enclosure provides a means to position the water-permeable enclosure in the flow of contaminated water.

In another aspect, the present disclosure provides for a device for treatment of contaminated water. A water-permeable enclosure encompasses a clay-based flocculant material for reducing a contaminant entrained in a flow of contaminated water. A filter attached to a downstream portion of the water-permeable enclosure provides a means to receive the flow of contaminated water. The device is shaped to be received and substantially encompassed within a passage that constrains the flow.

In an additional aspect, the present disclosure provides a method of treatment of contaminated water. A water-permeable enclosure is attached to a structure that confines a flow of contaminated water that entrains a contaminant and sediment, wherein the water-permeable enclosure encompasses a clay-based flocculant material selected to clarify the sediment and to reduce a contaminant entrained in the flow of contaminated water. The flow is directed to a filtering apparatus that captures sediment including the contaminant captured by the clay-based flocculant material.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts a diagram of a single-stage filtering device incorporating a flocculant bag with a product for reducing a contaminant in contaminated water according to one embodiment.

FIG. 2 depicts a diagram of a flocculant bag having loop hanger according to one embodiment.

FIG. 3 depicts a detail diagram of a portion of a flocculant bag having a pass-through opening for staking according to one embodiment.

FIG. 4 depicts an isometric view an exemplary use of flocculant bags.

FIG. 5 depicts an isometric view of another exemplary use of flocculant bags for treating contaminated water.

FIG. 6 depicts a diagram in side cutaway view of erosion control using flocculant bags and a clarification and settling basin.

FIG. 7 depicts a diagram of a sediment control system using augured flocculant material device that is augmented with a flocculant bag device. Although both devices are shown together, such a system may comprise one or the other or both devices.

FIG. 8 depicts an isometric view partially cutaway to show a tank containing side attached and outlet attached flocculant bags.

FIG. 9 depicts an isometric view partially cutaway to show erosion control measures at an outlet of a discharge pipe that augmented with a flocculant bag for treatment of contaminated water.

FIG. 10 depicts a side cutaway view of a groundwater drainpipe augmented with flocculant bags.

FIG. 11 depicts a side cutaway view of a storm drain system employing single-stage filtering devices.

FIG. 12 depicts a flow diagram of a method of providing and using flocculant bags for treatment of contaminated water, according to one embodiment.

### DETAILED DESCRIPTION

The present innovation relates generally to devices and methods for use in contaminant removal from water. The devices are for use in removal of a variety of environmentally regulated pollutants pertaining to storm water, erosion control compliance and waters generated in the construction, mining, excavation, and other regulated surface water containment and treatment operations.

The present innovation provides flocculant bags that release a flocculating agent for treating contaminated water.

“Flocculant” or “flocculating agent” means a composition of matter which when added to a liquid destabilizes, and aggregates colloidal and finely divided suspended particles or contaminants in the liquid, flocculants and coagulants can be flocculating agents.

Flocculation is the process of adding a flocculant, coagulant or other catalyst to water or wastewater to remove colloidal and finely divided suspended particles or contaminants in the liquid. The flocculant then binds with the contaminants to form flocculant as part of discharge sites or wastewater treatment. Thereby, solids are separated from liquid as the primary basis of the treatment.

In the present innovation, using natural products to bind colloidal and finely divided suspended particles or contaminants in a discharge site or wastewater performs flocculation. In particular, one or more products in the flocculant bag remove contaminants by a physical/chemical reaction of coagulation, flocculation and cation ion exchange. The contaminants not only “floc up” but also become encapsulated in the flocculant. In a particular aspect, the flocculants disclosed herein is designed to break emulsified oils as well as encapsulate heavy metals or entrained oil in a strong floc.

The flocculants may be formulated from chemicals that are either NSF/ANSI Standard 60: “Drinking Water Treatment Chemicals” approved for drinking water application, U.S. Food & Drug Administration (FDA) approved for direct human contact, or meeting the GRAS (“Generally Recognized As Safe”) status as defined by the FDA.

In one embodiment, the flocculant is a clay-based composition. Typically, the clay comprises smectite clay such as beidellite clays, hectorite clays, laponite clays, montmorillonite clays, nontonite clays, saponite clays, bentonite clays and mixtures thereof.

The term “filtering device” is used generically herein to describe a filtration system, encompassing terminology such as filter, strainer, separator, and the like. A filtering system may comprise one or more filtering devices.

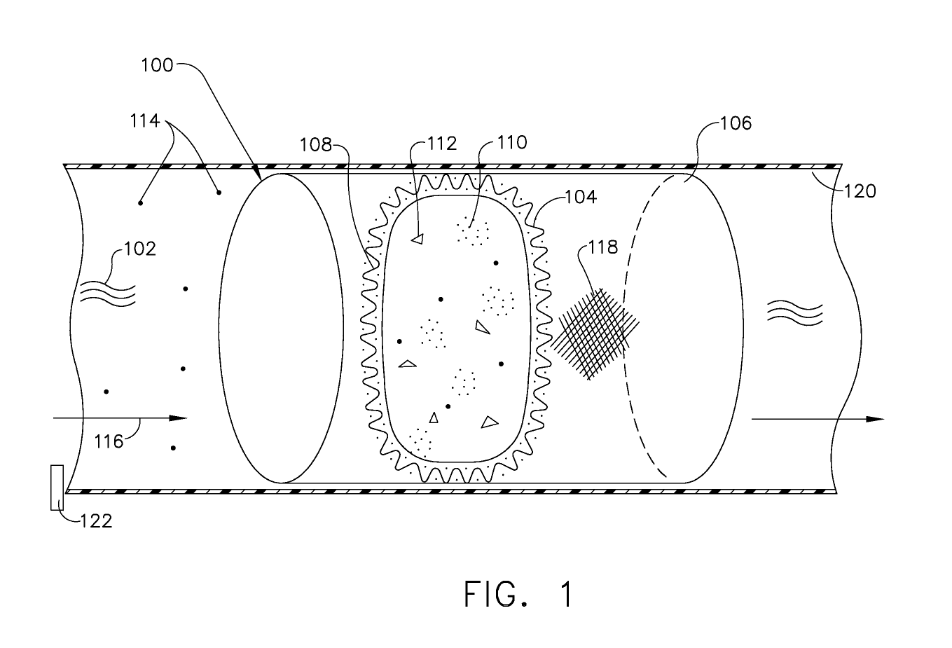

Turning to the drawings, in FIG. 1, a single-stage filtering device 100 is depicted for treatment of contaminated water 102 in a single stage by incorporating both an upstream flocculant bag 104 and a filtering portion 106 that is attached to and positioned downstream of the flocculant bag 104. A water-permeable enclosure 108 encompasses a clay-based flocculant material 110 that reduces a contaminant 114 entrained in a flow 116 of the contaminated water 102. In particular, flocculant 118 is produced by the dissolved flocculant material 110 encapsulating the contaminant 114 for filtering. In the exemplary single-stage filtering device 100, the flocculant is captured within the filtering portion 106.

In another embodiment, the clay-based flocculant material further comprises one or more additional flocculant or coagulant materials. In another embodiment, the flocculant product is a clay-based product further comprising one or more of alum, polyacrylamide, polyferric chloride, ferric acid, chlorides, and variants and derivatives thereof.

In one embodiment, the additional flocculant or coagulant agents comprise polymers (such as cationic polymers and anionic polymers); aluminum salts; quats and polyquats; calcium oxide; calcium hydroxide; ferrous sulphate; ferric chloride; polyacrylamide; sodium aluminate; sodium silicate; chitosan; gelatin; guar gum; alginates; moringa seeds; starch derivatives, or a combination thereof. In another embodiment, the additional flocculant or coagulant agents comprise soluble polyacrylamide homopolymer or copolymer.

In another embodiment, the additional flocculant or coagulant agents comprise polymers that are homo and copolymers of polar and generally ionizable unsaturated monomers such as acrylamide, N-methylolacrylamide, N-hydroxypropylacrylamide, acrylic acid, methacrylic acid, acrylate esters, maleic and fumaric acids, maleic anhydride, vinyl fulonates, and the like. Non-functional monomers such as alkyl acrylates, olefins, etc., may also be copolymerized. Coagulants include inorganic coagulants such as bivalent cationic oxides and salts. Examples are calcium chloride, calcium nitrate, calcium sulfate, magnesium chloride, magnesium nitrate, magnesium sulfate, calcium oxide and magnesium oxide. Trivalent cationic oxides and salts perform more effectively than bivalent oxides and salts. Among these are aluminum oxide, aluminum sulfate, aluminum chlorohydrate, aluminum perchloride and ferric chloride. Among the known organic coagulants are quaternary polyamines and PolyDADMAC (polydiallyldimethylammonium chloride).

The single-stage filtering device 100 may be shaped such that all or substantially all of the flow 116 passes through the device. In the exemplary depiction, the single-stage filtering device 100 is shaped to be encompassed by and to fill a passage 120 that constrains the flow 116. To that end, the single-stage filtering device 100 may be affixed or attached to the passage 120 or be held in place by an upstream attachment 122 as depicted.

In some examples of the flocculant bag 104, the clay-based product filling 112 to remove contaminant 114 may further include polyacrylamide compounds (anionic, nonionic and cationic) in composition. Other products may include chitosan and other absorbent or adsorbent compounds found in nature. Other products may include aluminum-based coagulants to include those compounds with an anionic part of the form of sulfate, chloride, polyaluminum chloride (PAC), chlorohydrate or other chloride based variants. Other products may include ferric or ferrous (iron) based coagulants to include those compounds with an anionic part of the form of sulfate, chloride, polyferric chloride (PFC), chlorohydrate or other chloride based variants. Other products may include a quantity of iron ore powder, which can be used to bind phosphorus. Other products may include predetermined additives, such as those described herein, including one or more herbicides, insecticides, pesticides, admixtures, aggregates, flocculants, polymers, chemical binders, and/or water absorbers, etc., chosen to enhance the performance in a predetermined environment.

Additional benefits of the exemplary flocculants are an ability to operate over a wide pH range (e.g., 4 to 12), to improve flocculant shear and mixing, to generate a high shear strength floc, to require no additional chemistry to dewater, to reduce an overall quantity of chemicals, to simplify the operations by using just one product, to increase settling rates, to increase hydraulic capacity, to increase flocculant size, to enhance removal of Biochemical Oxygen Demand (BOD) and Total Suspended Solids (TSS); to remove heavy metals, to reduce impact on Total Dissolved Solids (TDS) and Electrical Conductivity (EC), to meet U.S. Environmental Protection Agency (EPA) TCLP (Toxic Characteristic Leaching Procedure) testing standards to include sludge leachability, and to reduce operating costs.

In particular, an end result is removal of the majority of the CAM 17 heavy metals, hydrocarbons, suspended solids, turbidity, surfactants and other common water contaminants into floc particles that settle in a basin or are filtered. CAM is an acronym for California Administrative Manual, which is presently known as CCR or California Code of Regulations. CAM 17 refers to a list of heavy metals identified in the manual: antimony, arsenic, barium, beryllium, cadmium, chromium, cobalt, copper, lead, mercury, molybdenum, nickel, selenium, silver, thallium, vanadium, and zinc.

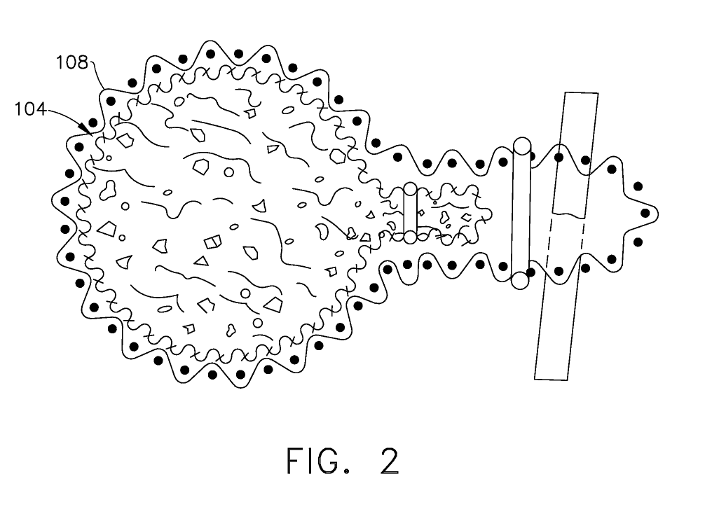

In FIG. 2, a flocculant bag 104 is depicted as separate from a filtering apparatus. The flocculant bag 104 may be positioned in the flow of contaminated waters by an attachment 130 that is coupled to or affixed, such as by tying or zip-tying, onto the water-permeable enclosure 108. In exemplary embodiments, the attachment 130 may be a loop hanger, cord loop, or an excess of netting around the flocculant bag 104 that can be looped or otherwise serves as an attachment such as by staking For example, the water-permeable enclosure 108 may comprise a biodegradable fibrous material contained within a non-biodegradable layer, such as a nylon netting having a loop hanger for serving as a placement member.

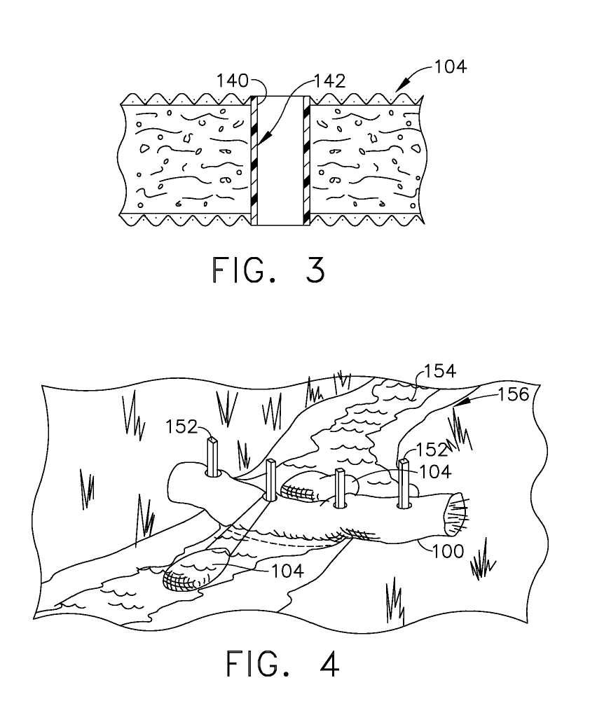

In FIG. 3, the flocculant bag 104 may include a pass-through opening 140 that can receive a stake or other attaching device for positioning the flocculant bag 104 in a flow of contaminated water. In an exemplary aspect, a non-permeable layer 142, such as a tube, may provide structural strength to avoid damage from the flow exerting a force on the flocculant bag 104 that reacts against the stake (not shown).

In FIG. 4, the single-stage filtering device 100 (FIG. 1) may be shaped as a flocculant sock 150, which is positioned in the instance by stakes 152 to impede a flow 154 such as in a drainage ditch 156. Flocculant bags 104 may be formed as erosion guard logs and erosion guard flats that contain blends of coagulants and flocculants as described herein for water clarification and erosion control. These devices may serve the same purpose as bags and socks, although the chemistry may be different. For instance, polyacrylamide and calcium gel materials may be put inside of netting. Generally, one tends to use one or the other, either flocculant bags or socks, over guard logs and flats. These guards reduce and prevent erosion of fine particles and colloidal clays from water. Calcium is commonly used to improve bridging between clay particles thereby virtually halting water induced soil erosion. In other embodiments, other compounds can be added, as described herein. Erosion guard logs and erosion guard flats may be used in flowing waterways and normally dry situations that could be subject to erosion due to flowing water. In either situation, exposure of the erosion guard logs and erosion guard flats to water flow will initialize the product and begin the clarification process. Flats may be placed across drain grates for Storm Water Filtration Devices (SWFDs), for example. The PAM will cause the fines in the soil to flocculate or clump together. This clumping creates larger, heavier soil particles, which will more easily be removed from the water by the sedimentary process. This settling of the clumps from the water flow results in effective erosion control. Erosion guard products may be used for the flocculation of sediment in waterways or discharge sites (reducing turbidity), in irrigation and erosion control practices to minimize erosion. Other uses include stabilization of irrigation or conveyance ditches by reducing water loss due to seepage.

Flocculant bags 104 may be implemented in a waste stream, ditch channel, sediment basin or pond by attaching the flocculant bag to a string/rope and staked into the ground. Pond and sediment basin applications can also be attached in multiples on a string/rope that spans the width of a basin or pond. Application of the flocculant bags 104 insures proper dosing as the Floc is dissipated according to turbidity and water flow, allowing for consistent dosing, relieving the contractor multiple applications, therefore reducing time/labor costs. Flocculant bags 104 are a great tool for reducing the turbidity (amount of sediment), hydrocarbons and heavy metals from your wastewater.

Flocculant bags 104 can also be used in conjunction with other typical sediment retention devices such as wattles, silt fence, ditch checks and hay bales by attaching the flocculant bags 104 via a zip tie to the sediment retention device (SRD). Replacement bags can then be attached over and over to the SRD when the flocculant has been dissipated out, therefore increasing the effectiveness of the SRD in controlling turbidity, heavy metal and hydrocarbon reduction. For example, a flocculant bags 104 weighing 4 lbs. may typically treat 4,000 gallons.

Applications include mine tailings and waste pile ditches, newly cleared construction or building site drainage; road and highway construction runoff ditches; water sheds; canals; ditch; placement for all forms of highly turbid waters, hillsides; and waste water.

In use, flocculant bags 104 may be positioned with other SRD/filtering apparatuses—alongside/attached to other SRDs such as wattles, rock check dams, silt fence, inlet filter devices, curb filter devices. Additional flocculant bags 104 may be positioned alongside the sediment retention device 150 to augment the amount of dissolved flocculant material and product. Alternatively to shaping a single-stage filtering device 100 as a sediment retention device 150, a flocculant bag 104 may be positioned upstream of a filtering apparatus such as a conventional sediment control device. Alternatively or in addition, a flocculant bag 104 may be positioned downstream of the conventional sediment retention device 150 for releasing flocculant material and product for settling or filtering further downstream.

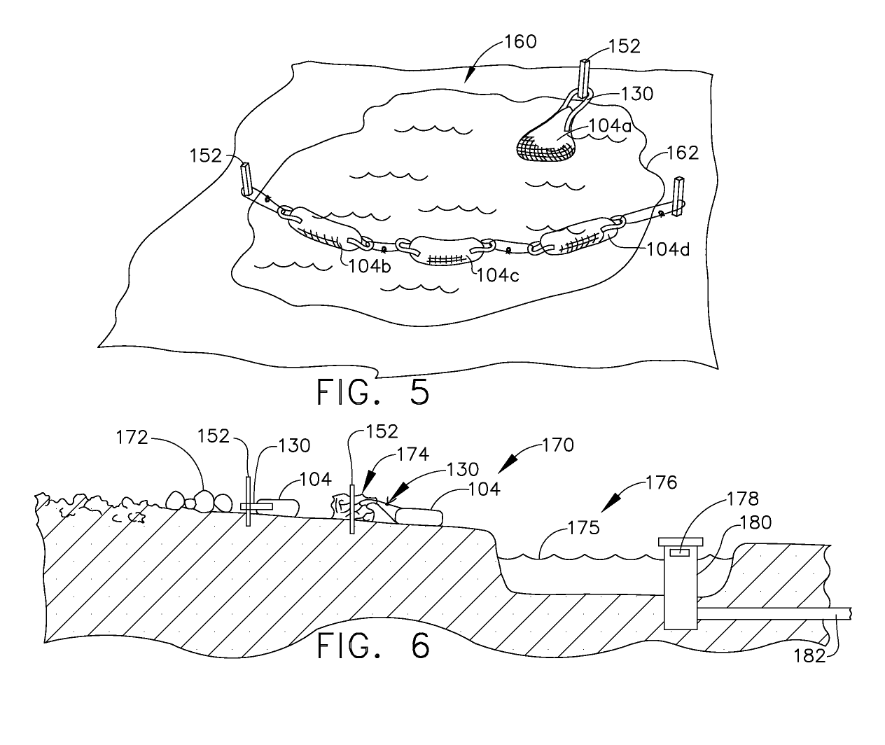

In FIG. 5, another exemplary arrangement 160 of flocculant bags are shown including staking a first flocculant bag 104a to an edge of a basin 162 and creating a combination of linearly attached flocculant bags 104a, 104b, 104c that are staked across the basin 162.

In FIG. 6, a sediment control system 170 is enhanced by use of flocculant bags 104. Erosion control measures such as rocks 172 and staked bales of straw 174 slow the flow of contaminated ground water to mitigate erosion. Flocculant bags 104 are tied or staked to present flocculant material and product to the flow, as well impeding the flow that accumulates as depicted at 175 in a filtering apparatus, specifically a settling basin or tank 176. Excess accumulates into an upper drain 178 in a standpipe 180 that communicates with an outlet pipe 182 that carries the treated water. In particular, flocculant bags 104 may be used before or after wattle. The flocculant bags 104 may be either formed into a bag or soc. For instance, most wattles are 10′ long, which may thus be traversed by two 5′ socs.

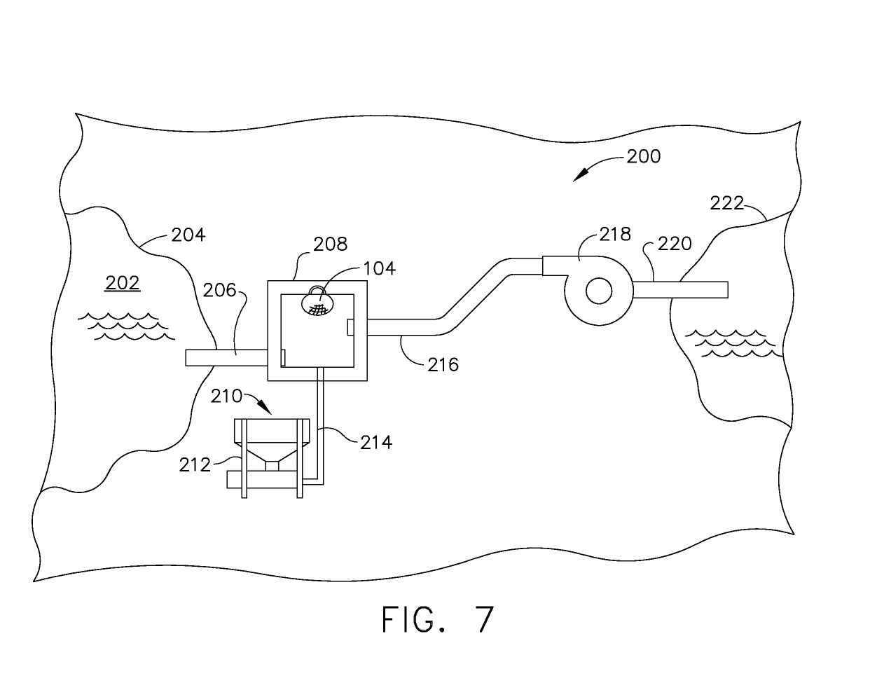

In FIG. 7, a sediment control system 200 removes sediment by treating contaminated water 202 with physically dispersed flocculant material to aid in settling of sediment for clarity. A flocculant bag 104 is introduced to the sediment control system 200 as a substitute means for removal of contaminates from contaminated source 204, such a first tank, pond, or basin. A conduit or pipe 206 is submerged slightly below a water level of the contaminated source 204 and is plumbed to gravity feed contaminated water 202 into an upper portion of a mixing stage or other containment, such as concrete tank (“holding/mixing tank”) 208. Thereby, use of a conventional floc feeder 210 may be discontinued. The floc feeder 210 has a bulk hopper 212 containing flocculant material that is augured into an auger line 214 that is physically dispersed into the holding/mixing tank 208 where the contaminated water is mixed with the flocculant therefore clarifying the contaminated water. A suction line 216 is plumbed from the bottom of the concrete tank, holding/mixing tank 208 to an inlet of a pump 218 whose outlet 220 transfers flocculant and treated water from the concrete tank 208 for clarification settling or filtering in a receiving target, such as a second tank, pond, basin or other devices or ditches 222.

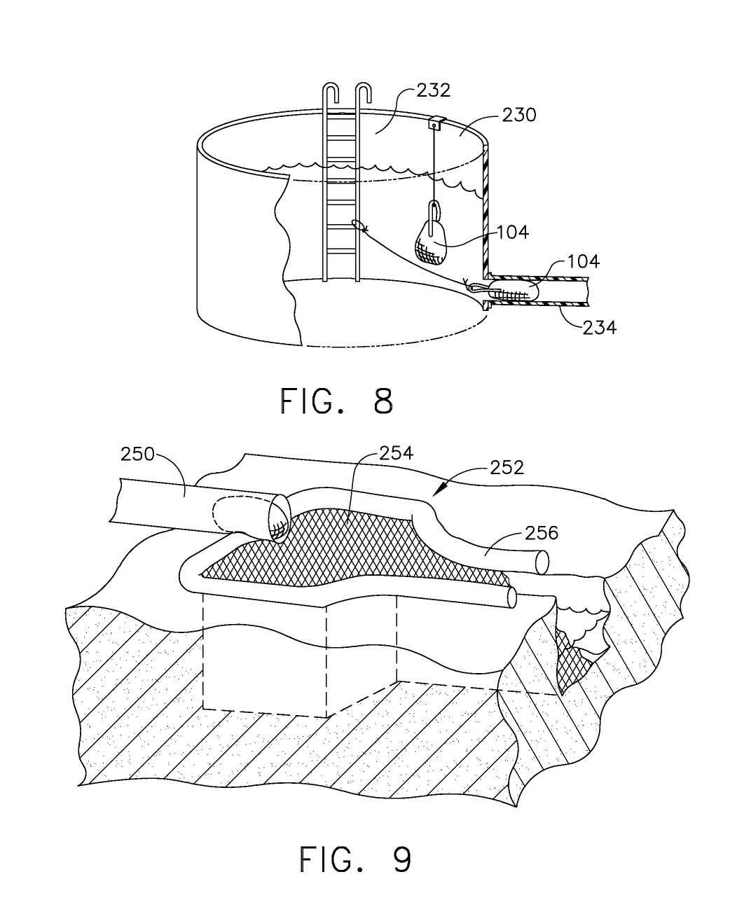

In FIG. 8, a tank 230 includes two exemplary uses of flocculant bags 104 by hanging one against a side wall 232 and another tied to remain within an opening of an outlet 234.

In FIG. 9, a pipe 250 that empties into a drainage ditch 252 incorporates erosion control measures as well as flocculant bags 104 for reducing contaminants and suspended solids. For example, a floc bag 104 may be held within the pipe 250 for introducing flocculant material, including any additional products, if present, to the contaminated water. A pile of fibrous organic material 254 surrounded by a flexible erosion control log 256 receives the flow from the pipe 250 to capture sediment and to mitigate erosion.

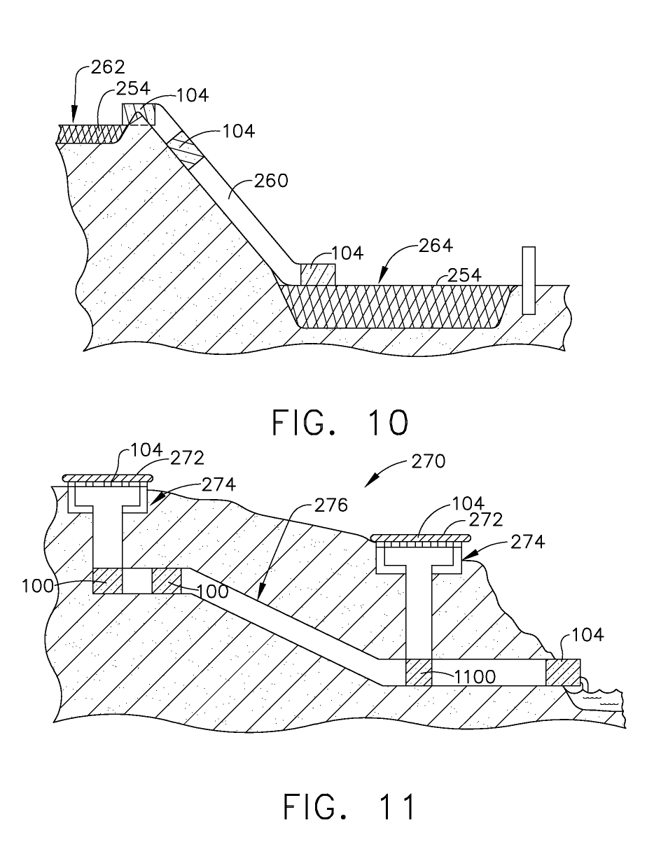

Similarly in FIG. 10, a pipe 260 serves as a conduit between an upper flow path 262 and a lower flow path 264 with one or more flocculant bags 104 held in the pipe 260. Fibrous organic material 254 can mitigate erosion and perform sediment capture.

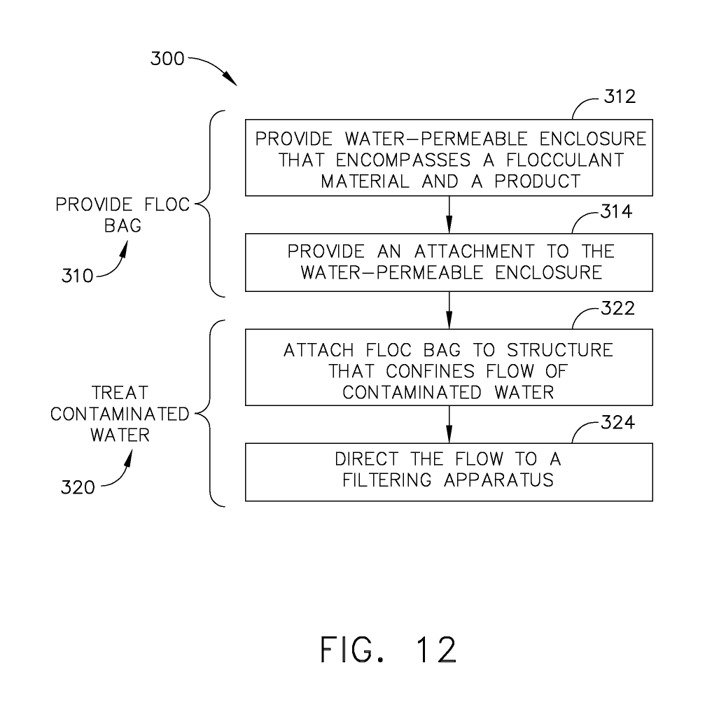

In FIG. 11, a storm drain system 270 incorporates flocculant bags 104 to treat contamination. In particular, erosion control flats (same as flocculant bags) 272 containing flocculant cover grates 274 that receive groundwater. Underground drain pipes or passages 276 may include single-stage filtering devices 100 or flocculant bags 104 for treating the water.

In FIG. 12, the present disclosure provides a method 300 for treating contaminated water. As depicted at 310, a flocculant bag is provided. In particular, a water-permeable enclosure encompasses a flocculant material selected to clarify the sediment and a product for reducing a contaminant entrained in the flow of contaminated water in block 312. For example, a permeated clay-based flocculant may be included. For another example, the water-permeable enclosure may be configured for a selected rate of dissolving of the flocculant material. For an additional example, the product may include a polyacrylamide compound. For a further example, the product may include chitosan. For yet another example, the product may include at least one of an aluminum-based coagulant selected from a group of compounds consisting of an anionic part of a chloride, polyaluminum chloride (PAC), and chlorohydrate. An attachment such as a loop hanger attached to netting is coupled to the water-permeable enclosure in block 314.

As depicted at 320, one or more flocculant bags are used to treat contaminated water. In particular, in block 322 the water-permeable enclosure of each flocculant bag is attached to a structure that confines a flow of the contaminated water that entrains the contaminant and sediment. In block 324, the flow is directed to a filtering apparatus that captures sediment including the contaminant captured by the product. For example, position or attach a filter downstream of the one or more flocculant bags. For another example, capture the flow in a clarification settling basin or tank.

In one exemplary aspect, directing the flow to the filtering apparatus may be filtering with a filter having permeability selected to capture sediment produced from a combination of dissolved flocculant material from the water-permeable enclosure and a material in the flow of contaminated water. In a particular embodiment, directing the flow to the filtering apparatus may be by placing an erosion control device substantially across the flow.

In a test of an exemplary FLOC™, clay-based flocculant material (Innovative Turf Solutions, Cincinnati, Ohio), the initial pH was 7.0 and the treated water was at a pH of 7.0. The sample required 0.45 grams/1,000 ml to form a good floc. This equates to 4 lbs./1,000 gallons treated or a dosage rate at 30 gpm of 7.2 lbs./hour (1,800 gph flow). The untreated and treated water results are shown below:

TABLE 1

| Constituent | Untreated | Treated |
|---|---|---|
| Biochemical Oxygen Demand (BOD) | Not Detected | Not Detected |
| Chemical Oxygen Demand (COD) | 16 | 21 |
| Total Organic Carbon (TOC) | 3.2 | 4.9 |
| Total Suspended Solids (TSS) | 120 | Not Detected |

Both inorganic and organic flocculating agents, and combinations thereof, are useful for the flocculant filling. In one embodiment, the clay-based flocculating agents further comprise anionic acrylic polymers, preferably anionic polyacrylamide. Many such flocculating agents are known, for example, organic flocculants which include nonionic, anionic, cationic, zwitterionic and other polymers, particularly polyacrylates, polyacrylate copolymers, polyacrylamides, polymethacrylamides, polyacrylamide/aerylic acid copolymers, polyamines, polyimines, melamine/formaldehyde condensates, etc.

Inorganic flocculants include lime, alum, ferric chloride, polyaluminum chloride, polyferric sulfate, sodium alginate, and bentonite, among others. Examples of flocculants and their use are disclosed in U.S. Pat. Nos. 3,957,904, 4,024,216, 4,155,847, 4,251,363, 4,370,464, 4,431,548, 4,990,263, 5,019,275, 5,035,808, 5,326,854, 5,725,780, 5,990,216, 6,531,531, 6,569,968, all herein incorporated by reference.

In another embodiment, the flocculant is supplied in a variety of sizes, so as to provide for sustained release. In one embodiment, the flocculant form may be that of particles, extrudates, etc. In one embodiment, the particles span a size range of about 25 to 6000 μm, more preferably 200 to 2000 μm.

Another embodiment of the present invention solves one or more of the problems in the art with an apparatus for collecting and treating contaminated water. In particular, one implementation of the present invention includes a mobile and integrated apparatus for continuously collecting and treating contaminated water with a portable unit that can be stationed at a contaminated water production site.

In another embodiment, the flocculant is supplied using a dewatering system container. The present invention also provides methods for collecting and treating contaminated water material with a portable apparatus that continuously collects and treats a contaminated water material.

Contaminated water material, as that term is used herein, can include any material that requires some form of treatment before it can be disposed of or otherwise discarded. A contaminated water material can include a variety of materials in various forms. By way of example only, contaminated water materials can include, but are not limited to, sludge from a drilling site, sewage, mud, dirt, dust, ash, and any type of sediment from a pit, pond, lagoon, tank bottom, or other enclosure.

A contaminated water material can be treated by mixing it with a flocculant treating material as described herein. As with the contaminated water material, a flocculant treating material can include a variety of materials in various forms. A flocculant treating material can be wet or dry. By way of example only, the flocculating agent used in the invention can further comprise additional materials including, but not limited to, saw dust, wood chips, cement kiln dust, lime kiln dust, ash, sulphuric acid, portland cement slurry, bentonite clay slurry, peat moss or other growing media, absorbent polymers, or any hydroscopic or cementitious material.

Contaminated water can be collected from a number of different sites that produce a contaminated water source material. These contaminated water production sites include but are not limited to drilling sites, manufacturing plants, mines, paint and other chemical factories, refineries, and power plants. The contaminated water material from these sites can be delivered to a mobile collecting and treating apparatus as described in the present invention in a number of different ways.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein. As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. An apparatus for treatment of contaminated water, comprising:
a clay-based flocculant material for reducing a contaminant entrained in a flow of contaminated water;
a water-permeable enclosure encompassing the clay-based flocculant material; and
a placement member attached to the water-permeable enclosure to position the water-permeable enclosure in the flow of contaminated water.

2. The apparatus of claim 1, wherein the clay-based flocculant material further comprises a polyacrylamide composition.

3. The apparatus of claim 1, further comprising a filter having permeability selected to capture sediment produced from a combination of dissolved flocculant material from the water-permeable enclosure and a material in the flow of contaminated water.

4. The apparatus of claim 3, wherein the filter comprises a sediment control device.

5. The apparatus of claim 3, wherein the filter is attached to the water-permeable enclosure.

6. The apparatus of claim 1, further comprising a settling basin that received the flow of contaminated water to capture sediment produced from a combination of dissolved flocculant material from the water-permeable enclosure and a material in the flow of contaminated water.

7. The apparatus of claim 1, wherein the clay-based flocculant material includes a permeated clay-based flocculant.

8. The apparatus of claim 1, wherein the water-permeable enclosure is configured for a selected rate of dissolving of the flocculant material.

9. The apparatus of claim 1, wherein the clay-based flocculant material further comprises at least one of an aluminum-based coagulant selected from a group of compounds consisting of an anionic part of a chloride, polyaluminum chloride (PAC), polyacrylamides, and chlorohydrate.

10. A device for treatment of contaminated water, comprising:
a clay-based flocculant material for reducing a contaminant entrained in a flow of contaminated water;
a water-permeable enclosure encompassing the clay-based flocculant material; and
a filter attached to a downstream portion of the water-permeable enclosure to receive the flow of contaminated water,
wherein the device is shaped to be received and substantially encompassed within a passage that constrains the flow.

11. The device of claim 10, the clay-based flocculant material further comprising a polyacrylamide composition.

12. A method of treatment of contaminated water, comprising:
attaching a water-permeable enclosure to a structure that confines a flow of contaminated water that entrains a contaminant and sediment, wherein the water-permeable enclosure encompasses a clay-based flocculant material selected to clarify the sediment and to reduce a contaminant entrained in the flow of contaminated water; and
directing the flow to a filtering apparatus that captures sediment including the contaminant captured by the clay-based flocculant material.

13. The method of claim 12, wherein directing the flow to the filtering apparatus comprises filtering with a filter having permeability selected to capture sediment produced from a combination of dissolved clay-based flocculant material from the water-permeable enclosure and a material in the flow of contaminated water.

14. The method of claim 13, wherein directing the flow to the filtering apparatus comprises placing a sediment control device substantially across the flow.

15. The method of claim 13, wherein directing flow to the filtering apparatus further comprises attaching filtering apparatus to a downstream portion of the water-permeable enclosure.

16. The method of claim 12, wherein directing the flow to the filtering apparatus comprises directing the flow to a settling basin that receives the flow of contaminated water to capture sediment produced from a combination of dissolved flocculant material from the water-permeable enclosure and a material in the flow of contaminated water.

17. The method of claim 12, wherein the flocculant material includes a permeated clay-based flocculant.

18. The method of claim 12, wherein the water-permeable enclosure is configured for a selected rate of dissolving of the flocculant material.

19. The method of claim 12, wherein the water-permeable enclosure encompasses the clay-based flocculant material comprising polyacrylamide compound.

20. The method of claim 12, wherein the clay-based flocculant material comprises at least ones an aluminum-based coagulant selected from a group of compounds consisting of an anionic part of a chloride, polyaluminum chloride (PAC), and chlorohydrate.
